(19) United States
(12) Patent Application Publication
(10) Pub. No.: US 2012/0061597 A1
(43) Pub. Date: Mar. 15, 2012

(54) DIAPHRAGM VALVE DRIVE

(75) Inventor: Guido Erich Speer, Selm (DE)

(73) Assignee: ALFA LAVAL CORPORATE AB, Lund (SE)

(21) Appl. No.: 13/322,283

(22) PCT Filed: May 27, 2010
(86) PCT No.: PCT/EP2010/003217

§ 371 Date: Nov. 23, 2011

(30) Foreign Application Priority Data
May 28, 2009 (DE) 10 2009 023 002.5

(51) Int. Cl. F16K 35/00

(52) U.S. Cl. 251/89

(57) ABSTRACT

The invention relates to a device for securing and positioning a handling element on a diaphragm valve (1), comprising a lower part (2) having an external screw thread (3) and forming the valve seat and a pot-shaped element (5) having an internal screw thread (18) and accommodating the diaphragm adjusting unit. The aim of the invention is to devise a means for mounting manual actuators and drives on diaphragm valves (1) without torque wrenches, other tools, labeling, drawings and other aids. To achieve this aim, the external screw thread (3), in its end section (16), or the stop ring (19) for the pot-shaped element (5) on the lower part (2) has a mechanical blocking/stop element (7, 7′) and the respective corresponding threaded surface (8) or end face (20) of the pot-shaped element (5) has a detent (9, 9′) having an inlet and outlet ramp (10, 10′) for the blocking/stop element (7, 7′).

The invention pertains to a device for securing and positioning a drive or handling element (actuator) on a diaphragm valve, there being provided an externally threaded lower part forming the valve seat and an internally threaded pot-shaped element accommodating the diaphragm adjusting mechanism.

Diaphragm valves of this kind—especially standard diaphragm valves, tank bottom discharge valves, block valves, T-valves, tandem valves, multi-port valves and/or welded-design valves—are used in a multitude of industrial and commercial processes and have been known by DE 73 33 464 U and U.S. Pat. No. 5,326,078 A, among others. Conventional assembly thereof is time consuming and expensive. In regular practice, a set of four screws is used to connect the required upper handling part or the drive unit (especially pneumatic, electric or hydraulic drives) to the diaphragm valve body; moreover, assembling them requires considerably precision in relying on shop and assembly drawings, markings and prescribed torques. In the process, it is necessary to make sure that the screw-receiving through-bores in the valve drive body or in the manually operable upper portion are aligned precisely with the screw-receiving bores in the valve body. In addition, spring washers must be placed on the screws. Thereafter, the screw—having the spring washer placed on its head—is introduced from the valve body side through the screw-receiving bores in the valve body and is initially screwed by hand into the valve body. This assembly process is repeated with three more screws, which must then be tightened on the valve body uniformly and diagonally, under strict observance of the tightening torques given in pertinent technical documentation for the screws fastening the valve drive to the valve body. As the diaphragms may set with time, it is necessary to check the tightening torques before the valves are put into operation and then in regular intervals throughout the service life thereof. At the same time, attention must be paid to not use excessive force when tightening the screws. Excessive tightening torques may damage the diaphragms and the valve drive. Damaged valve drives or diaphragms render the assembly dysfunctional and may result in malfunction.

In addition, there exist diaphragm valves having so-called central screw threads. These are diaphragm valves comprising an externally threaded bottom part forming the valve seat and an internally threaded pot-shaped element housing the valve-adjusting mechanism. Centrally threaded connections of this kind are assembled by means of torque wrenches as well. Periodic re-tightening and re-adjustment are necessary throughout the valve's service life. Absolute freedom from leakage is not guaranteed when putting the valves into operation or when assembling them.

Further, commercially available diaphragm valves may vary in diaphragm quality. The various qualities or grades are marked by a type index on a lug or pad on the diaphragm, which index extends laterally from the valve body so that the diaphragm grade may be read externally without opening the valve. However, at the same time, the lug presents a danger of the diaphragm suffering mechanical injury, being contaminated, ripped off, or the like.

On this basis, it is the object of the invention to create a solution which—in the assembly of manually operated top parts and drives to diaphragm valves—obviates the use of torque wrenches or other tools, markings, drawings and other aids. Also, the lugs or pads are to be replaced by a sturdier solution.

In accordance with the present invention, this object is attained by providing a mechanical blocking or stop element in the end section of the external threads or in the stop ring for the pot-shaped element on the lower valve part, and by providing a detent having an inlet/outlet ramp for the blocking/stop element in the corresponding thread surface or end face of the pot-shaped element.

Recognizably, the invention results in the screw-together elements being retained or locked in place in defined end positions, said locked position marking the desired assembled condition acoustically or optically.

Further developments of the invention are defined in the dependent claims. These may include the mechanical blocking/stop element being formed by spring-biased detent, with a particular development of the invention residing in the use of a spring-biased ball to form said spring-biased detent.

Further characterizing particularities of the various elements of the inventive device include the presence of a physical and/or coloured marking on the lower valve part for optically indicating the detent-locked or indexed position, said marking being readable in a window of the pot-shaped element, and/or the ball having thereon coloured markings to identify the diaphragm grade.

In addition, the invention relates to a corresponding method of positioning and locking the drive or handling element in position on a diaphragm valve.

The invention will now be illustrated by way of embodiment examples under reference to the attached drawings.

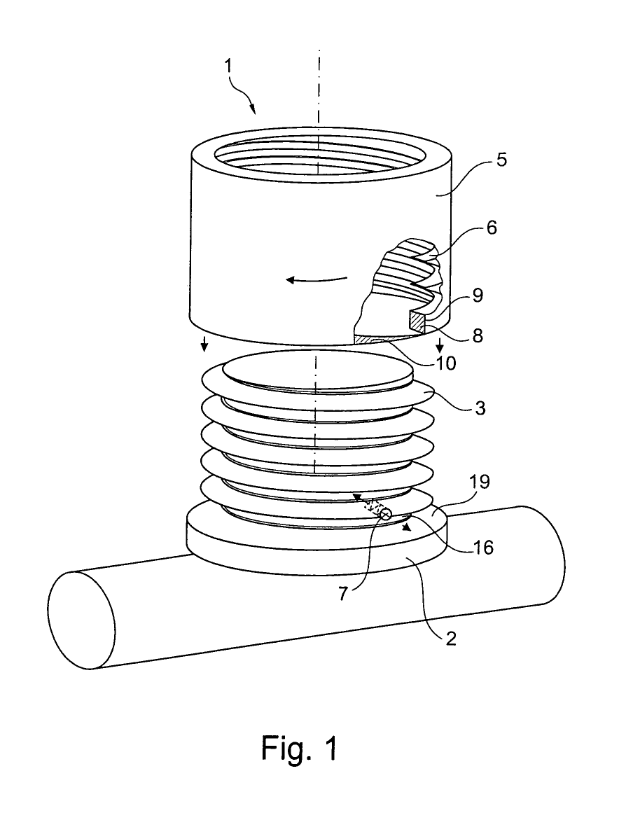

FIG. 1 shows a perspective view of an inventive diaphragm valve comprising a blocking/stop element in the end section of the external threads;

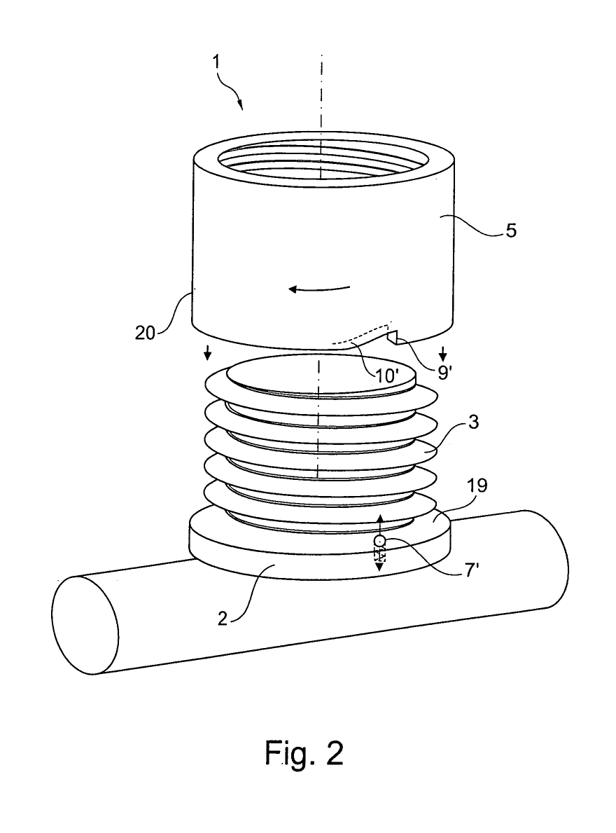

FIG. 2 shows a perspective view of a diaphragm valve comprising a blocking/stop element in the stop ring for said pot-shaped element;

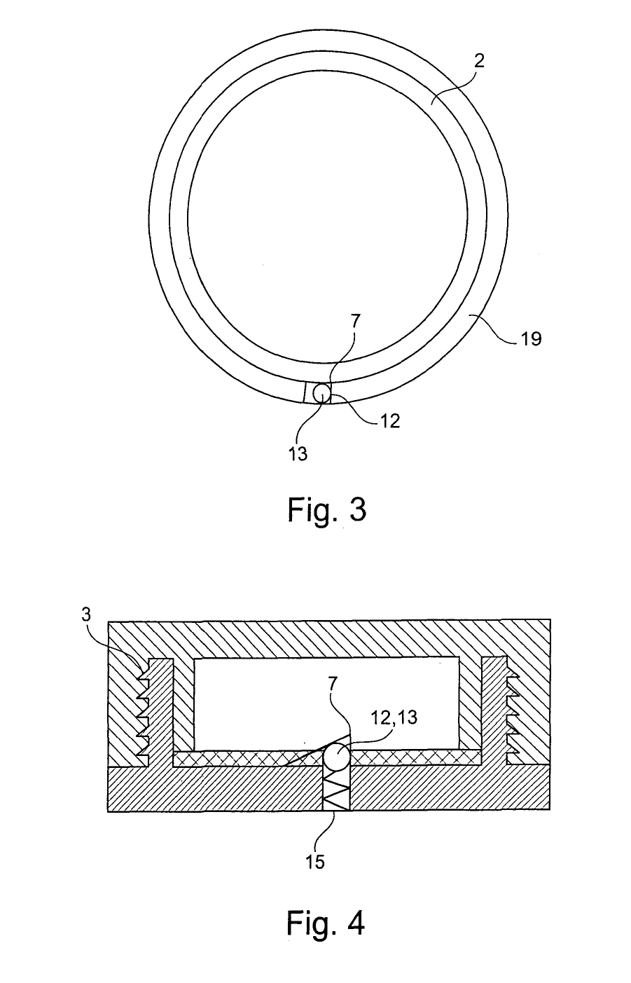

FIG. 3 shows a plan view of the end portion of the pot-shaped element on the lower valve part;

FIG. 4 shows a section through the externally threaded lower valve part and the internally threaded pot-shaped element screwed down thereon as well as a spring-biased detent and a ball;

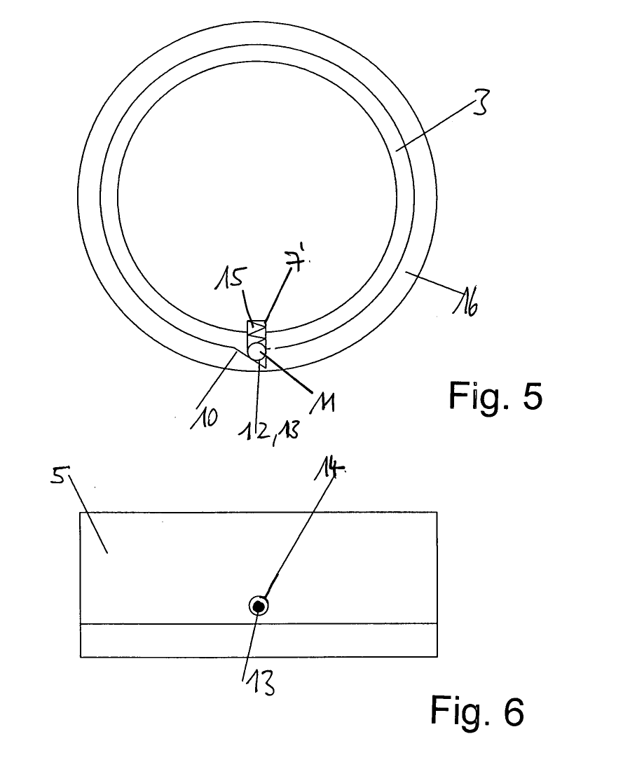

FIG. 5 shows a plan view of the end portion of the external thread on the lower valve part, as well as a spring-biased detent and a ball; and

FIG. 6 shows a side view of the pot-shaped element and an indicating window therein.

A diaphragm valve—generally referred to as 1—comprises a lower valve part 2 defining the valve seat and having external threads 3 (central threads) thereon, a stop ring 19, and a pot-shaped element 5 having internal threads 6 therein and housing the diaphragm-adjusting unit (not shown in detail).

A mechanical blocking/stop element 7, 7′ and—in the corresponding thread surface 8 or end face 20 of pot-shaped element 5—a detent 9, 9′ including an inlet/outlet ramp 10, 10′ for blocking/stop element 7, 7′ are provided in end section 16 of external threads 3, or in stop ring 19 for pot-shaped element 5 on lower valve part 2, with said mechanical blocking/stop element 7, 7′ formed by a spring-biased detent 11. In more detail, spring-biased detent 11 comprises a ball 12 biased by a spring 15. For optically identifying the locked position, there is provided on lower valve part 2 a physical and/or coloured marker 13 viewable and readable externally through a window 14 provided in pot-shaped element 5. In particular, ball 12 may be colour-marked to identify the type of diaphragm.

The operation of the inventive device is as follows:

The upper valve part or the valve drive unit or any other handling element (not shown in detail) is seated in a pre-defined position on outer threads 3 of lower valve part 2 (central threads) of the diaphragm valve and is screwed down manually into its final position by means of a pot-shaped element 5 having internal threads 6 and provided on the manually operable upper valve part or on the drive unit. A leakage-free condition of diaphragm valve 1 is guaranteed by a corresponding pre-defined pitch of the threads, the proper positioning of outer threads 3 and the pre-defined stop, with the bias being constant throughout. Once the end position has been reached, further tightening of internally threaded (6) pot-shaped element 5 is not possible any longer. Rather, there are provided in the end section 16 of outer threads 3, or in stop ring 19 for pot-shaped element 5, on lower valve part 2 a mechanical blocking/stop element 7, 7′ and—in the corresponding thread surface 8 or end face 20 of pot-shaped element 5—a detent 9, 9′ having an inlet/—outlet ramp 10, 10′ for blocking/stop element 7, 7′. Thereby any further rotation or overwinding is not possible any longer; at the same time, a firm and fluid-tight seated condition is guaranteed. If the mechanical blocking/stop element 7, 7′ is formed by a spring-biased detent 11 and, especially, by a ball 12 biased by a spring 15, the elements are locked in position automatically. Conveniently, the return angle for inlet/outlet ramp 10, 10′ is selected so that the breakaway torque is lower than the release torque. As a result, an unintentional release of the handling element 17, and especially of the manually operable upper part or of the drive, under shocks, vibrations and the like, as may occur in actual operation, will not be possible any more. Instead, if it is desired to replace the valve's diaphragm, for example, the manually operable upper valve part or the drive unit, i.e. pot-shaped element 5, must be loosened by applying a correspondingly higher force. No re- tightening and re-adjustment will be necessary for the entire service life of the valve. To facilitate assembly, physical and/or coloured markings may be provided on lower valve part 2 for optically indicating and identifying the locked position, such markings to be readable externally through a corresponding—window-shaped—opening 14 or the like in pot-shaped element 5. In particular, ball 12 may be marked in colour to identify the type or grade of the diaphragm used. In this case, the locking mechanism 12 and the indicating device 13 form an integral unit.

The diaphragm will be fluid-tight externally and internally for its entire service life. As desired, the exact mechanically locked condition may be signalled optically or acoustically by a clicking sound. The optical indication or click confirms the proper positioning of the valve, i.e. the leak-proof seated condition of the diaphragm, and the required locked condition so that internally threaded pot-shaped element 5 cannot turn during operation. The means used are, in particular, specialized short spring-loaded plungers properly dimensioned for existing loads in the resilient region or in the totally compressed condition of the spring.

The invention is not restricted to the embodiment examples illustrated above. Further developments are possible without departing from the principles underlying the invention. The only important point is that the drive unit or the manually operable upper part is positioned and locked in position without using tools, i.e. by a mechanical lock, and that, optionally, said positioning and lock are indicated optically and/or acoustically.

1. Apparatus for securing and locking in position a drive or handling element on a diaphragm valve (1) comprising a lower part (2) defining the valve seat and having external threads (3) thereon and a pot-shaped element (5) housing the diaphragm adjusting mechanism and having internal threads (6) therein, characterized by a mechanical blocking/stop element (7, 7′) provided on the lower part (2) in end section (16) of external threads (3) or in stop ring (19) for pot-shaped element (5), and by a detent (9, 9′) having an inlet/outlet ramp (10, 10′) for blocking/stop element (7) and situated in the respective corresponding thread surface (8) or in end face (20) of pot-shaped element (5).

2. Apparatus as claimed in claim 1, characterized in that said mechanical blocking/stop element (7, 7′) is formed by a spring-biased detent (11).

3. Apparatus as claimed in claim 2, characterized in that said spring-biased detent (11) is formed by a ball (12) biased by a spring (15).

4. Apparatus as claimed in claim 3, characterized in that there is provided for optically identifying the locked position a physical and/or coloured marking located on lower part (2) and readable in a window (14) in pot-shaped element (5).

5. Apparatus as claimed in claim 3, characterized by a coloured marking (13) of ball (12) for identifying the type of diaphragm used.

6. Apparatus for securing and locking in position a drive or handling element on a diaphragm valve (1) comprising a lower part (2) defining the valve seat and having external threads (3) thereon and a pot-shaped element (5) housing the diaphragm adjusting means and having internal threads (6) therein, characterized in that pot-shaped element (5) is screwed down manually on lower part (2) until a mechanical blocking/stop element (7, 7′) in end section (19) of said external threads (3), or in stop ring (19) for pot-shaped element (5), snaps in position on lower valve part (2) in a detent (11) having an inlet/outlet ramp (10, 10′) for blocking/stop element (7, 7′) in the corresponding thread surface (8) or in end face (20) of pot-shaped element (5) so as to automatically place and lock said drive or handling element in the proper position.

7. A process as claimed in claim 6, characterized in that the proper positioning and locking in place of the drive or handling element is indicated optically and/or acoustically by means of a clicking sound.
